(19) United States
(12) Patent Application Publication
(10) Pub. No.: US 2013/0219040 A1
(43) Pub. Date: Aug. 22, 2013

(54) STORAGE AREA NETWORK CONFIGURATION OF VITUAL FIBRE CHANNEL PORTS PRIOR TO CLIENT CREATION

(71) Applicant: International Business Machines Corporation, (US)

(72) Inventors: Maria D. Garza, Round Rock, TX (US); Krishnakumar R. Jinka, Bangalore (IN); Greg R. Mewhinney, Austin, TX (US); James A. Pafumi, Leander, TX (US)

(73) Assignee: International Business Machines Corporation, Armonk, NY (US)

(21) Appl. No.: 13/848,076

(22) Filed: Mar. 21, 2013

Related U.S. Application Data
(63) Continuation of application No. 13/275,638, filed on Oct. 18, 2011.

(51) Int. Cl. H04L 12/24

(52) U.S. Cl. CPC H04L 41/08
USPC 709/223

(57) ABSTRACT

Provided are techniques for providing a user interface on a storage virtualizer, the user interface configured to enable a worldwide unique identifier (WWPN) to be selectively activated on a storage area network (SAN), and setting up a zoning for the WWPN on the SAN prior to installation of a virtual I/O client and without a requirement that the user manually enter the WWPN.

### CROSS-REFERENCES TO RELATED APPLICATIONS

The present application is a continuation and claims the benefit of the filing date of an application entitled, “Storage Area Network. Configuration of Virtual Fibre Channel Ports Prior to Client Creation” Ser. No. 13/275,638, filed Oct. 18, 2011, assigned to the assignee of the present application, and herein incorporated by reference.

### BACKGROUND OF THE INVENTION

The claimed subject matter relates generally to electronic communication and, more specifically, to techniques for the setup and configuration of communication channels.

Provided are techniques for the setup and configuration of communication channels in a manner that simplifies client login to a storage area network (SAN) and reduces administrator workload,

Fibre channel nport identifier virtualization (NPIV) is a technology that enables a fibre channel adaptor to virtualize a physical port. At one time, each port of a fibre channel adapter was assigned a single worldwide unique identifier (WWPN). Now, a storage virtualizer is able to assign multiple WWPNs to a single physical port. In one popular implementation of the NPIV standard, a WWNP intended to be applied to an nport is supplied by a client's virtual adapter when a client partition corresponding to the client executes a fibre channel login to access the client's storage.

### SUMMARY

Provided are techniques for providing a user interface on a storage virtualizer, the user interface configured to enable a worldwide unique identifier (WWPN) to be selectively activated on a storage area network (SAN), and setting up a zoning for the WWPN on the SAN prior to installation of a virtual I/O client and without a requirement that the user manually enter the WWPN.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the ad upon examination of the following figures and detailed description.

### BRIEF DESCRIPTION OF THE DRAWINGS

A better understanding of the claimed subject matter can be obtained when the following, detailed description of the disclosed embodiments is considered in conjunction with the following figures, in which:

FIG. 1 is a computing system architecture on which the disclosed subject matter may be implemented.

FIG. 2 is a block diagram logical partitions (LPARs), a hypervisor (HYPR), a virtual input/output server (VIOS), a hardware management console (HMC) and a storage area network (SAN), all of which were first introduced, in FIG. 1, in more detail.

FIG. 3 is a flowchart of Setup Storage process that ma implement aspects of the claimed subject matter.

FIG. 4 is a flowchart of a Connect Client process that may implement additional aspects of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable. RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

In current NPIV technology, one problem is that the WWPN assigned to an upon is not visible on a storage area network (SAN) until a client executes a process login using the logical unit number (LUN) assigned to the client. This limitation creates a “chicken and egg” problem for a SAN administrator in that the administrator cannot easily zone and configure the client's SAN access until a client's WWPN is visible on the SAN and they cannot install and boot the client and until the SAN is configured to provide the storage for the client. Currently, the administrator must manually configure the SAN by querying a virtualization manager that controls the assignment of WWPNs to determine the WWPNs that will be assigned to the client and, then type each sixteen (16) digit hexadecimal number corresponding to yet to be assigned WWPNs into a SAN management tool. Obviously, this process is error prone, time consuming and tedious for the SAN administrator.

A secondary problem is related to the configuration for a SAN for live partition mobility (LPM). A current implementation of LPM with respect to NPIV employs two (2) WWPNs for each virtual adapter of a virtualization manager. A second WWPN enables a client to briefly be logged in to both a source and destination storage virtualizers. However, many users do not initially plan to use LPM and, as a result, do not bother to set up the secondary WWPN when the SAN is configured. Then, if the user wishes to use the user must manually enter the secondary WWPN into the SAN management tool. The disclosed technology addresses both the first and secondary problems.

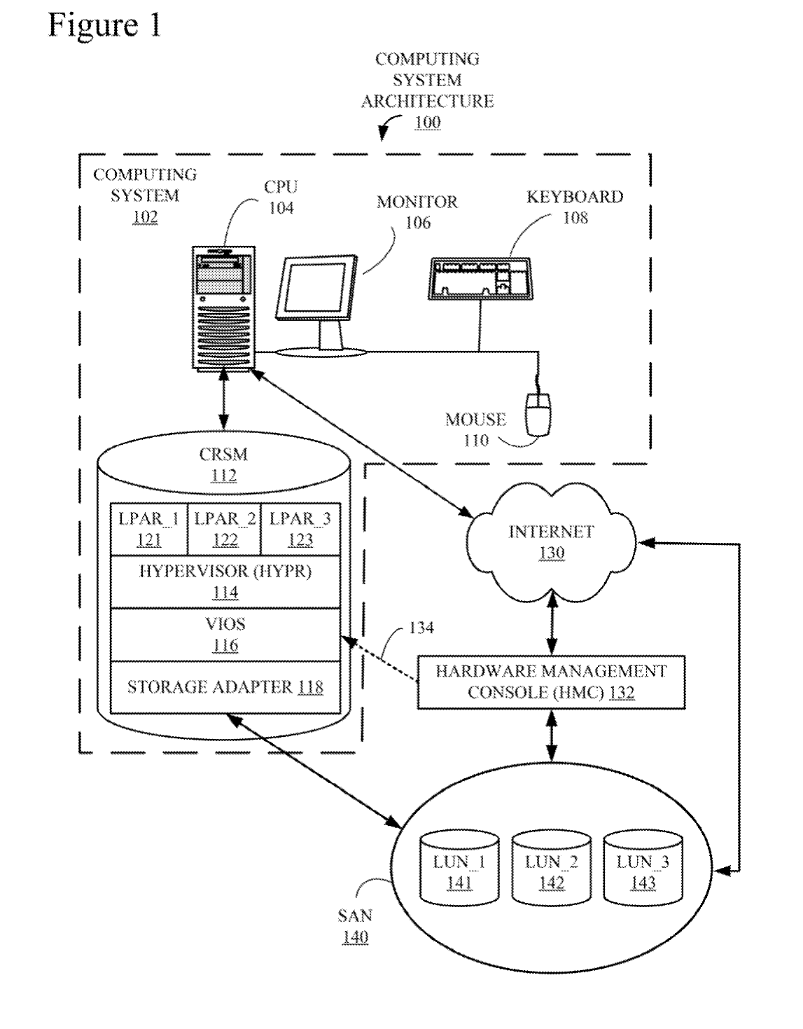

FIG. 1 is a computing system architecture 100 on which the disclosed subject matter may be implemented. A computing system 102 includes a central processing unit (CPU) 104, coupled to a monitor 106, a keyboard 108 and a pointing device, or “mouse,” 110, which together facilitate human interaction with components of computing system architecture 100 and computing system 102. Also included in computing system 102 and attached to CPU 104 is a computer-readable storage medium (CRSM) 112, which may either dynamic or non-dynamic memory and incorporated into computing system 102 i.e. an internal device, or attached externally to CPU 104 by means of various, commonly available connection devices such as but not limited to, a universal serial bus (USB) port not shown).

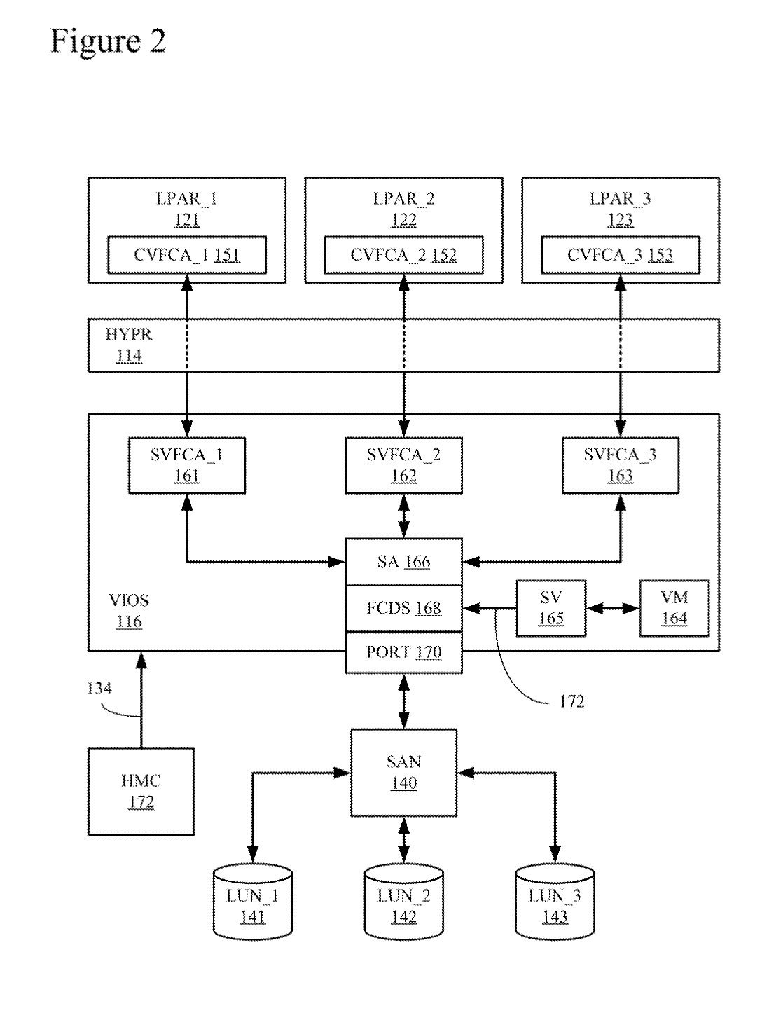

CRSM 112 is illustrated storing a hypervisor (HYPR) 114 and a number of logical partitions, or LPARs, i.e. a LPAR_{—}1 121, a LPAR_{—}2 122 and a LPAR_{—}3 123. As should be familiar to one with skill in the relevant arts, each of LPAR 121-123 may implement a different operating system (OS) such that multiple OSs (not shown) are able to run concurrently on computing system 102. Also stored on CRSM 112 are a virtual input/output server (VIOS) 116 and a storage adapter 118, which handle data storage tasks associated with LPARs 121-123. The implementation and coordination of LPARs 121-123, the respective OSs, HYPR 114, VIOS 116 and storage adapter 118 are explained in more detail below in conjunction with FIGS. 2-4.

Computing system 102 is connected to the Internet 130, which is also connected to a hardware management console (HMC) 132. Although in this example, computing system 102 and HMC 132 are communicatively coupled via the internet 130, they could also be coupled through any number of communication mediums such as, but not limited to, a local area network (LAN) and a wide area network. (WAN). Also provided is a channel 134 between HMC 132 and VIOS 116. HMC 132 enables an administrator to configure and control the various elements of computing system architecture 100, including, but not limited to, computing system 102, HYPR 114, VIOS 116 and a storage area network (SAN) 140. Although not illustrated, HMC 132 would typically include a CRSM and one or more processors to store and execute, respectively, logic associated with HMC 132 as well as a monitor, keyboard and mouse. Although illustrated as a standalone component, HMC 132 may also be incorporated into another component, including but not limited to computing system 102, in which case INC 132 may utilize components such as CRSM, processors, monitor, keyboards and mouse of the other component. SAN 140 is illustrated as containing three storage devices, or logical units, i.e. a LUN_{—}1 141, a LUN_{—}2 142 and a LUN_{—}3 143. It should be noted there are many possible computing system configurations, of which computing system architecture 100 is only one simple example

FIG. 2 is a block diagram of LPARs 121-123, HYPR 114, VIOS 116, HMC 172 and SAN 140, all of which were first introduced in FIG. 1, in more detail, LPARs 121-123 each include a client virtual fibre channel adapter (CVFCA), i.e. a CVFCA_{—}1 151, a CVFCA_{—}2 152 and a CVFCA_{—}3 153, respectively. CVFCAs 151-153 are each coupled, via HYPR 114, with a corresponding server virtual fibre channel adapter (SVFCA.) in VIOS 116, i.e. a SVFCA_{—}1 161, a SVFCA_{—}2 162 and a SVFCA_{—}3 163, respectively. SVFCAs 161-163 are coupled to a storage adapter, i.e. SA 166. SA 166 is coupled to a fibre channel driver stack (FCDS) 168, which controls a physical port 170. Port 170 provides a communication path from VIOS 116 to SAN 140. Each of CVFCAs 151-153 and SVFCAs 161-163 is assigned a unique WWPN and these WWPNs are typically managed by either HMC 172 and/or VIOS 116.

Any particular WWPN may be “logged in” to SAN 140. SAN 140 is correspondingly configured to provide access to the CVFCA 151-153 or SVFCA 161-163 that corresponds to the particular WWPN. In a common scenario, VIOS 116 for HMC 172) supplies a WWPN to a CVFCA, and the corresponding LPAR, which in this example will be CVFCA_{—}1 151 and LPAR_{—}1 121. LPAR1 121 then used the supplied WWPN to login to SAN 140 by-passing the WWPN to SAN 140 via CVFCA_{—}1 151, SVFCA_{—}1 161, SA 166, FCDS 168 and port 170. The WWPN is then visible on SAN 140 so that SAN 140 may be configured. Typically, each LPAR 121-132 is only configured to use SAN 140 via one of the corresponding CVFCA 151-153 or SVFCA 161-163 at any particular time.

The disclosed technology provides a second path for a WWPN to be logged into SAN 149, a path that does not involve the diem such as LPARs 121-123. In one embodiment, a WWPN is supplied by a virtualization manager 164 to VIOS 116 and then from a storage virtualizer 165 of VIOS 116 directly to FCDS 168 via as channel 172. In this manner, SAN 140 may be configured with a particular WWPN prior to a client such as LPARs 121-123 attempting to login via a CVFCA 151-153 or SVFCA 161-163. The disclosed technology provides the ability for a secondary virtual fibre channel adapter (VFCA), such as CVFCA 151-153 of SVFCA 161-163, to be configured on SAN 140 in a manner that is quicker and more efficient than the prior art. In addition, the disclosed technology may also be employed to login a primary VCFA more quickly and efficiently.

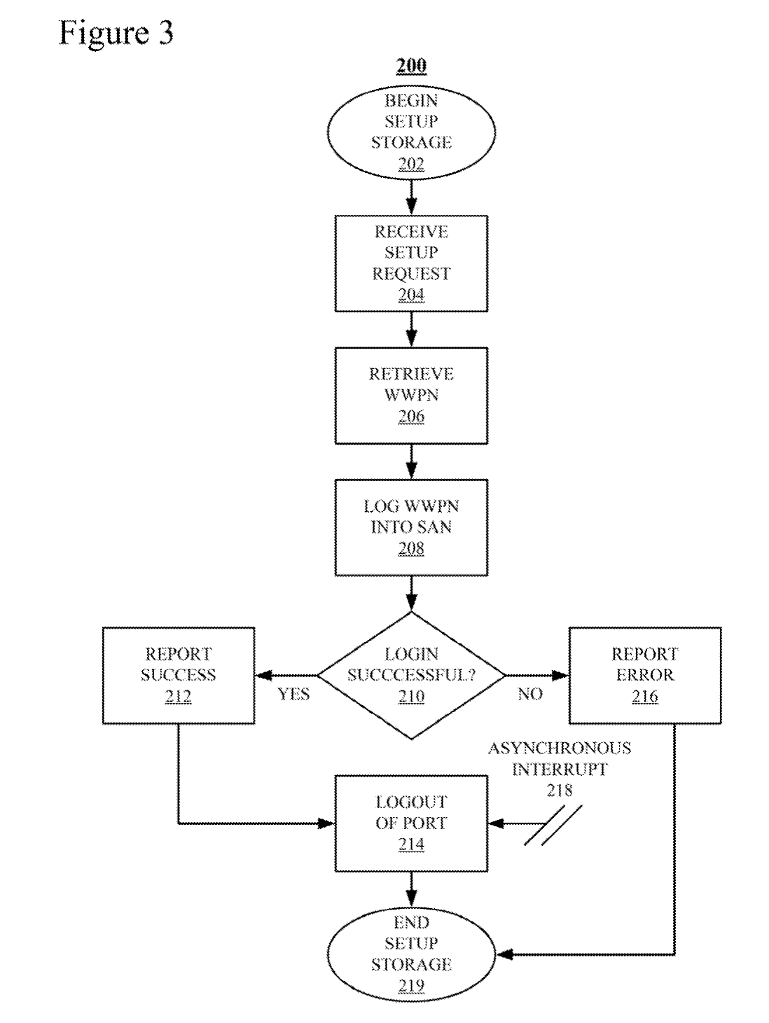

FIG. 3 is a flowchart of Setup Storage process 200 that may implement aspects of the claimed subject matter. In this example, logic associated with process 200 is associated with VM 164 (FIG. 2) and SV 165 (FIG. 1) of VIOS 116 (FIGS. 1 and 2), stored on a CRSM 112 (FIG. 1) and executed on one or more processors (not shown) associated with CPU 104 (FIG. 1).

Process 200 starts in a “Begin Setup Storage” block 202 and proceeds immediately to a “Receive Setup Request” block 204. In one embodiment, process 200 may be initiated by an administrator operating through a user interface associated with, for example but not limited to VIOS 116 or HMC 172 (FIGS. 1 and 2). During processing associated with block 204, a request to configure SAN 140 (FIGS. 1 and 2) is received. During processing associated with a “Retrieve WWPN” block 206, a WWPN is requested and received from VM 164. During processing associated with a “Log WWPN Into SAN” block 208, the specific WWPN retrieved during processing associated with block 206 is transmitted via FCDS 168 (FIG. 2) to SAN 140 where an administrator can log the WWPN into SAN 140, i.e., set up zoning, for the WWPN, as though a client, e.g. LAPR_{—}1 121 (FIGS. 1 and 2) has made the request.

During processing associated with a “Login Successful?” block 210, a determination is made as to whether or not the login request initiated during processing associated with block 208 was successful. Typically, a determination of success would be based upon an acknowledgement transmitted from SAN 140 to VIOS 116 and a determination of failure would be based upon either an explicit failure message or because of the expiration of a timer (not shown). If a determination of success is made, the administrator who initiated the request is notified, during processing associated with a “Report Success” block 212, that the WWPN has been established on SAN 140. In addition, LPAR_{—}1 121 is notified of the successful establishment of the WWPN on SAN 140.

During processing associated with a “Logout of Port” block 214, VIOS 116 logs out of the port established during processing associated with blocks 206 and 208 so that the client for whom the port was established, which in this example is LPAR_{—}1 121 (FIGS. 1 and 2), may login using the WWPN retrieved during processing associated with block 206. An Asynchronous interrupt 218 is triggered if LPAR_{—}1 121 initiates a login to the same WWPN retrieved during, processing associated with block 206. In this manner, any potential conflict between process 200 and a logon attempt by LPAR_{—}1 121 is avoided.

If during processing associated with block 210, a determination of a login failure is made, the administrator is notified, during processing associated with a “Report Error” block 216, of that fact so that appropriate actions may be taken. Finally, once processing associated with either blocks 212 or 216 is complete, control proceeds to an “End Setup Storage” block 219 during which process 200.

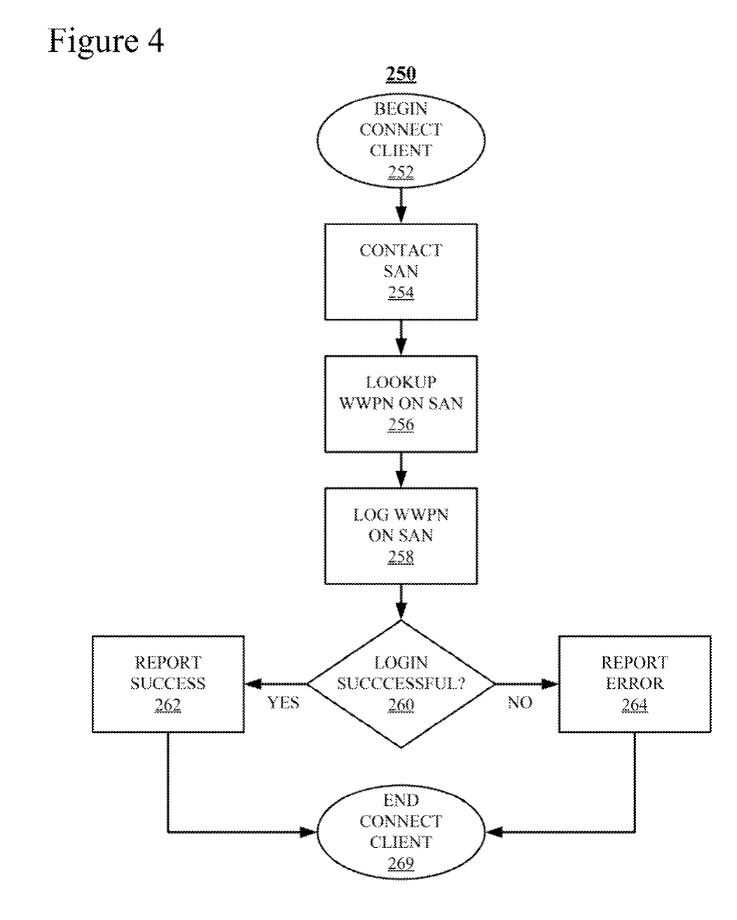

FIG. 4 is a flowchart of a Connect Client process 250 that may implement additional aspects of the claimed subject matter. In this example, logic associated with process 250 is stored on CRSM 112 (FIG. 1) and executed on one or more processors not shown) associated with CPU 104 (FIG. 1) of computing system 102 (FIG. 1). In addition, in this example, the client is LPAR_{—}1 121 (FIGS. 1 and 2).

Process 250 starts in a “Begin Connect Client” block 252 and proceeds immediately to a “Contact SAN” block 254. During processing associated with block 254, LPAR_{—}1 121 contacts SAN 140 (FIGS. 1 and 2) to establish a WWPN for storage. During processing associated with a “Lookup WWPN on SAN” block 256, SAN 140 verifies that a WWPN supplied to LPAR_{—}1 121 (see 212, FIG. 3) and transmitted to SAN 140 by VIOS 116 in conjunction with the logon request is properly configured (see 208, FIG. 3).

During processing associated with a “Log WWPN on SAN” block 258, LPAR_{—}1 121 logs into SAN 140 using the supplied WWPN. During processing associated with “Login Successful?” block 260, a determination is made as to whether or not the login executed during processing associated with block 258 was successful. If so, control proceeds to a “Report Success” block 262. During processing associated with block 262, an administrator who initiated the storage allocation request is notified of the completion. If, during processing associated with block 260, a determination is made that the request did not succeed, the administrator is notified during processing associated with a “Report Error” block 264. Finally, during processing associated with an “End Connect Client” block 269, process 250 is complete.

In this manner, a particular WWPN login request made by LPAR_{—}1 121 may he “pre-configured,” In other words, by enabling VIOS 116 to login a WWPN that is to be used by LPAR_{—}1 121, partitions on SAN 140 corresponding to the particular WWPN may be configured prior to an actual login request by LPAR_{—}1 121. In addition, if LPAR_{—}1 121 attempts to login to the particular WWPN on SAN 140 while VIOS 116 is attempting to login the same WWPN, an interrupt (see 218, FIG. 3) halts the attempt by VIOS 116 to prevent a conflict. It should also be understood that there exists a mechanism for logging the WWPN off the SAN in consideration of live partition mobility (LPM) For example, if VM 164 moves a client such as LAPRs 121-123 from one server on SAN 140 to another server, the WWPN is logged out of SAN 140 so that the secondary WWPN that was logged in may be employed in a validation phase of LPM.

The terminology used herein is fur the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best. explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising;
providing a user interlace on as storage virtualizer, the user interface configured to enable a worldwide unique identifier (WWPN) to be selectively activated on a storage area network (SAN); and
setting up a zoning for the WWPN on the SAN prior to installation of a virtual I/O client that utilizes the WWPN and without a requirement that the WWPN be manually entered.

2. The method of claim 1, further comprising logging the storage virtualizer of WWPN on the SAN prior to the virtual I/O client logging into the SAN to utilize the WWPN.

3. The method of claim 1
wherein the WWPN is a fibre channel nport identifier virtualization (NPIV); and
wherein the NPIV enables a fibre channel adapter to virtualize a physical port utilizing a first virtual fibre channel (VFC) adaptor on a first partition and a second VFC on the storage virtualizer working together to form a pair, the pair moving fibre channel commands and data.

4. The method of claim 1, further comprising:
detecting a login attempt by the virtual I/O client of the WWPN on the SAN; and
aborting the selective, activation of the WWPN on the SAN by the storage virtualizer in response to the detecting

5. The method of claim 1, further comprising:
detecting a move of the virtual I/O client from a first server to a second server; and
logging the WWPN out of the SAN in response to the detecting.

6. The method of claim 1, wherein the virtual I/O client is a logical partition (LPAR) on a client computing system.

7. The method of claim 1, wherein the user interface is incorporated into a virtual I/O server (VIOS) on a client computing system.

8. The method of claim 1, wherein the user interface is incorporated into a hardware management console.
